(19) United States
(12) Patent Application Publication
(10) Pub. No.: US 2001/0034797 A1
(43) Pub. Date: Oct. 25, 2001

(54) Data transferring method and communication network system

(76) Inventors: Kei Kato, Chiba (JP); Hisanori Shiba, Chiba (JP)

Correspondence Address: Venable, P.O. Box 34385, Washington, DC, 20043-9998, US

(21) Appl. No.: 09/797,970

(22) Filed: Mar. 5, 2001

(30) Foreign Application Priority Data
Apr. 21, 2000 (JP) 120249/2000

(51) Int. Cl. G06F 15/16

(52) U.S. Cl. 709/245; 709/201

(57) ABSTRACT

This invention provides an improved data transferring menthol performed in a communication network comprising a management system M1 and a plurality of nodes. Since the management system M1 collectively manages the algorithm information that indicates algorithm possessed in each node, if the fist node does not have algorithm needed for processing a certain packet, the first node can find the second node with the algorithm by requesting the network management unit M1 to send protocol information. In addition, the first node can transfer the certain packet to the second node to process the certain packet by using the algorithm.

### BACKGROUND OF THE INVENTION

1. Field of the Invention

The present invention generally relates to a data transferring method applied to a communication network system, such as a public telephone network and a data communication network.

2. Description of the Related Art

In general, a conventional communication network system comprises a plurality of nodes each that has a switching function and accommodates terminal equipments (TEs). Each of the nodes stores protocols and information needed for transferring packets and then determines a destination address of received packets based on the protocols and the information. Since there are many types of protocol including the up-grade edition of the same type of protocol, nodes have to transfer the protocol itself (for example, algorithm needed for performing the protocol) and the information each other to maintain the newest condition of the protocol and the information. As a result, the traffic for transferring both the protocol itself and the information rapidly increases according to the number of the nodes. Further the increase in the traffic causes delay of obtaining the protocols and the information or obstructions of real-time processing of a data transferring function. For example, if a packet that is required to an extraordinary protocol is input, it may take a great deal of time to transfer the packet to a destination address because each node has to obtain the extraordinary protocol.

### SUMMARY OF THE INVENTION

It is therefore an object of the present invention to provide an improved data transferring method to avoid the increase in the traffic due to transferring a protocol itself.

It is another object of the present invention to provide an improved communication network system to avoid the increase in the traffic due to transferring protocol itself.

In order to achieve the above object of the present invention, a data transferring method performed in a communication network system comprising a management system and a plurality of nodes, the method comprising steps of;

storing protocol information in the management system, the protocol information indicating transferring functions operable by each of the plurality of the nodes,

receiving, at a first node, a packet having a destination address,

detecting, at the first node, a transferring function needed for transferring the received packet,

requesting the management system to send the first node a second node information regarding a second node having the transferring function if the transferring function is not provided with the first node,

sending the second node information from the management system to the first node,

sending the packet from the first node to the second node according to the second node information to perform the transferring function for the packet,

performing, at the second node, the transferring function for the packet,

returning the packet from the second node to the first node, and

transferring the packet to the destination address.

Further, in order to achieve another object of the present invention, a communication network system comprising a management system and a plurality of nodes, wherein the management system comprises;

an algorithm management unit for storing protocol information that indicates transferring functions possessed by each of the plurality of nodes, and

a network management unit for communicating with the plurality of nodes and for providing node information that indicates a node having a transferring function based on the protocol information, and

a first nodes comprises;

a detecting unit for detecting a required transferring function needed for transferring a received packet having a destination address,

a requesting unit for sending the request signal to the network management unit to obtain a second node information regarding a second node having the required transferring function when the first node is not provided with the required transferring function, and

a transferring unit for transmitting the received packet to the second node according the second node information to perform the transferring function for the received packet and for transferring the received packet to the destination address after receiving the received packet from the second node.

### BRIEF DESCRIPTION OF THE DRAWINGS

A preferred form of the present invention is illustrated in the accompanying drawings in which:

FIG. 1 is a simplified block diagram of a communication network system in accordance with the first embodiment of the invention;

FIG. 2 is a simplified block diagram of a node according to the first embodiment of the invention;

FIG. 3 is a simplified block diagram of a management system in accordance with the first embodiment of the invention;

FIG. 4 is a data file indicating protocol information (algorithm information) according to the first and second embodiments of the invention;

FIG. 5 is a flow chart showing an requesting operation of a node in accordance with the first embodiment of the invention;

FIG. 6 is a simplified block diagram of a communication network system in accordance with the second embodiment of the invention; and

FIG. 7 is a simplified block diagram of a node according to the second embodiment of the invention.

### DETAILED DESCRIPTION OF THE PREFERRED EMBODIMENTS

A. First Embodiment of the Invention

The first embodiment of the present invention will be described below with reference to a preferred embodiment in conjunction with the accompanying drawings.

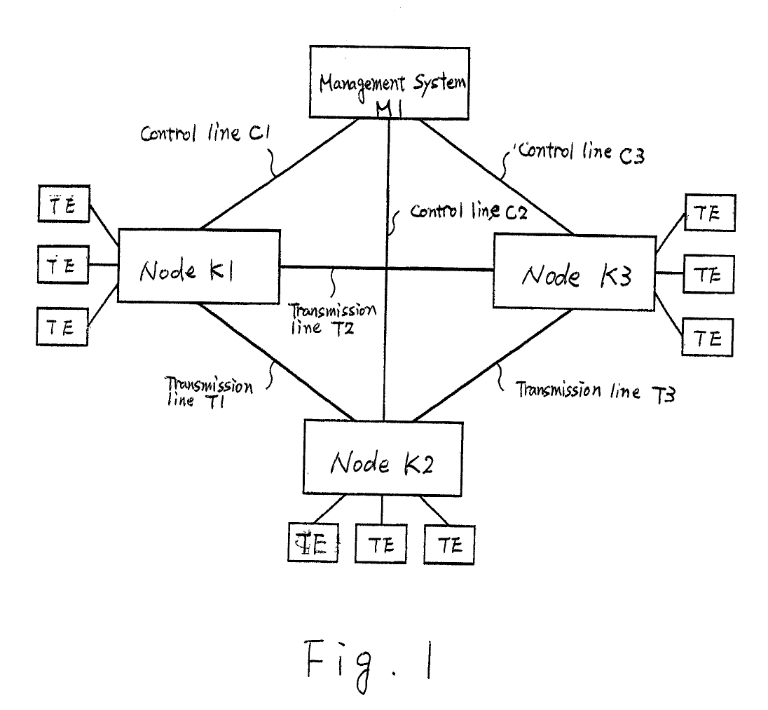

FIG. 1 shows a communications network system comprising nodes K1-K3 and a management system M1. Each of the nodes K1-K3 is, for example, a switching unit having a switching function or a router having a forwarding function and accommodates terminal equipments (TE). Thus, when a packet to be transferred to a destination address is input, each of the nodes K1-K3 transfers the packet to the destination address by performing suitable algorithm as a transferring function.

In FIG. 1, the node K1 is connected to the nodes K2 and K3 thorough transmission lines T1 and T2 respectively, and the node K2 is connected to the node K3 through a transmission line T3. In addition, the management system M1 is connected to the nodes K1-K3 thorough control lines C1-C3 respectively.

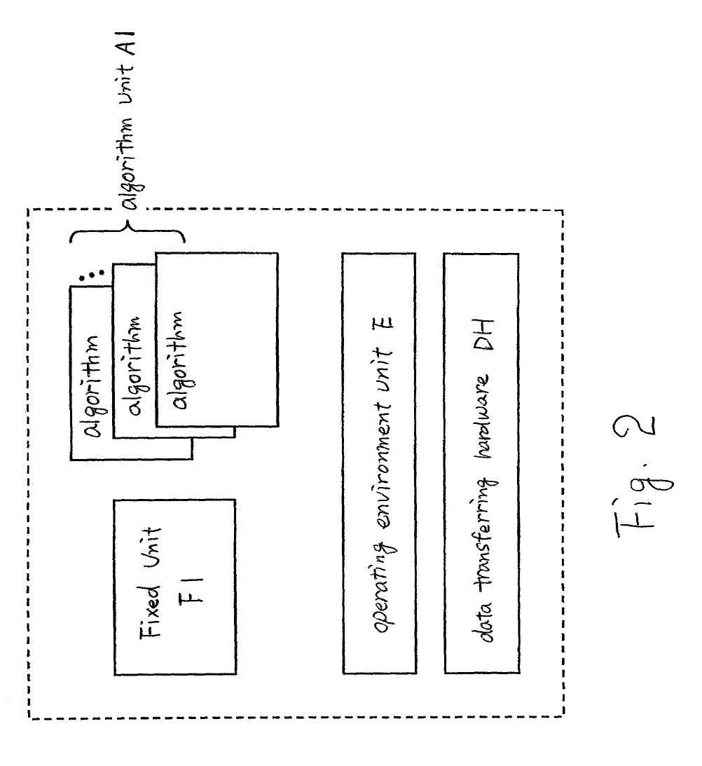

FIG. 2 shows a simplified block diagram of the nodes K1-K3. As shown in FIG. 2, each of the nodes K1-K3 comprises a fixed unit F1, an algorithm unit A1, an operating unit E1 and a data transferring hardware DH1. The fixed unit F1, the algorithm unit A1 and an operating unit E1 are generally realized by software. The data transferring hardware DH1 comprises a central processing unit (CPU), a memory unit, an I/O interface.

The fixed unit F1 performs functions, as parts of data transferring functions, for maintaining a state of packets to be transferred and the function are generally realized by application software. However, all or a part of the functions may be realized by an operating system instead of the application software. The fixed unit F1 also has a detecting function for detecting a transferring function (algorithm) needed for transferring a received packet and an requesting function for requesting the management unit M1 to send a protocol information (algorithm information) that indicates algorithms possessed by each node, as described in detail later.

The algorithm unit A1 has supplemental functions in addition to transferring received packets, for example performing the computer virus check of the received packets, and the functions are generally realized by application software. However, all or a part of the functions may be realized by an operating system instead of the application software. For instance, algorithms stored in the algorithm unit A1 corresponds to the protocol information mentioned above. In general, a number of and a type of algorithm stored in algorithm unit A1 depends on each node.

The operating unit E1 provides an environment to perform the functions of the fixed unit F1 and the algorithm unit A1, and it is generally realized by an operating system. However, all or a part of the functions may be realized by application software instead of the operating system. The operating unit E1 also exchanges packets with the data transferring hardware DH including the I/O interface.

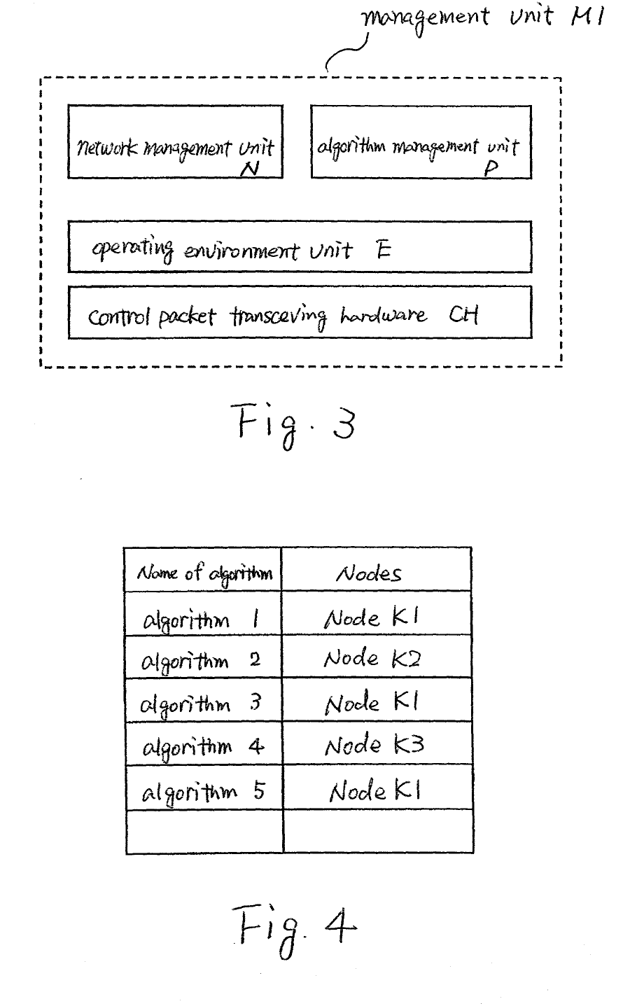

FIG. 3 shows a simplified block diagram of the management system M1, which is comprised of a network management unit N2, an algorithm management unit P2, an operating unit E2, and control packet transceiving hardware CH2. The network management unit N2, the algorithm management unit P2 and the operating unit E2 are generally realized by software, and the control packet transceiving hardware CH2 is comprised of a central processing unit, a memory and an I/O interface.

The network management unit N2 has functions to perform a network management operation, and the functions are generally realized by application software. However, all or a part of the functions may be realized by an operating system instead of the application software. The network management unit N2 also sends collecting order signals to all nodes via the control lines such that each node notifies algorithm stored in itself to the network management unit N2 as protocol information.

The algorithm management unit P2 manages algorithms used in the communications network system, and these functions are generally realized by application software. However, all or a part of the functions may be realized by an operating system. Thus, the algorithm management unit P2 makes and stores a data file indicative of a relationship between algorithm and node when the protocol information is provided from each node.

The operating unit E2 provides an environment to perform the functions of the network management unit N2 and the algorithm management unit P2, and these functions are generally realized by an operating system. However, all or a part of the functions may be realized by application software instead of the operating system. The operating unit E2 also exchanges control packet signals with the control packet transceiving hardware CH2 including the I/O interface. In this embodiment, the packets have been described as control packet signals in packet communication, however other signal forms can be adapted to the communication network system according to the this embodiment of the present invention.

An outline of a data transferring operation performed on the communication network system according to this embodiment will be described below. As mentioned above, the management system M1 collectively manages the protocol information indicative of algorithm possessed in each node. Thus, if the fist node does not have certain algorithm necessary for processing a supplied packet, the first node can find the second node having the certain algorithm by obtaining the protocol information of the network management unit M1. The first node then transfers the certain packet to the second node to have the packet processed and receives the processed packet from the second node.

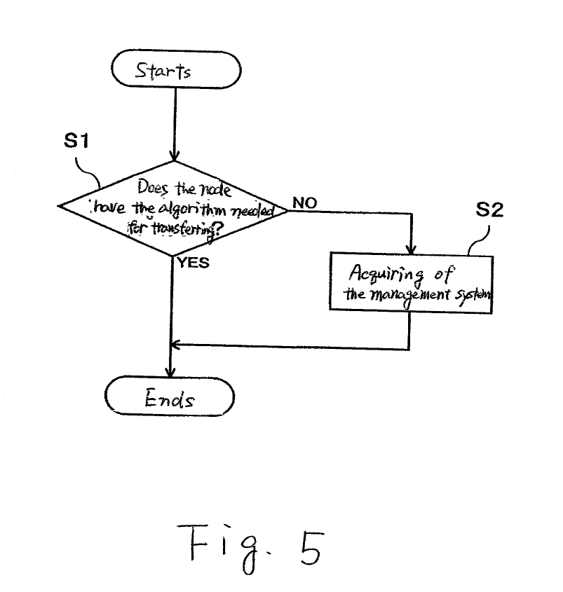

The registering operation of the algorithm will be described below with reference to FIG. 4, which shows a data file (protocol information) indicative of a relationship between algorithm and nodes. First, the management system M1 sends request packet signals to nodes that are administrated by the management system M1. In response to the reception of the request packet signals, each node informs the management system M1 of respective algorithm as protocol information. The protocol information informed by each node is provided to the algorithm management unit P2, which makes and stores the data file indicating nodes and its algorithm as shown in FIG. 4. The request packet signals are sent to each node periodically, and then the data file is renewed in response to the reception of the protocol information replied by each node. Alternatively, each node can send the algorithm information voluntarily and periodically regardless of receiving the request packet signals.

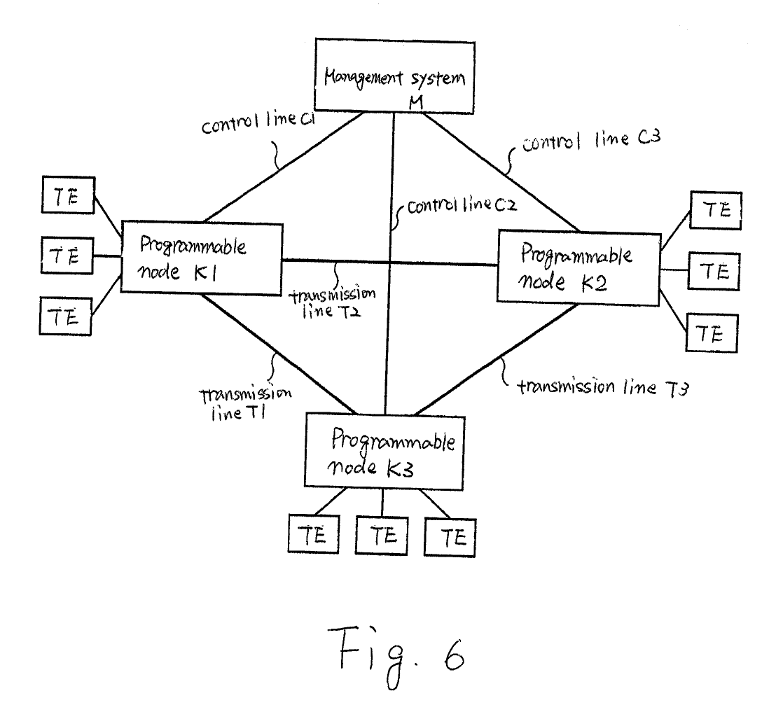

The data transferring operation will be described below in detail. It is assumed that the node K1 (shown in FIG. 1) receives a packet from a certain node (not shown). The packet is provided to the fixed unit F1. The fixed unit F1 performs an operation shown in FIG. 5, that is, the fixed unit F1 estimates algorithm necessary for processing the packet and examines whether or not the node K1 stores the algorithm in the algorithm unit A1 (S1). If the node K1 stores the algorithm, the packet is supplied to the algorithm unit A1, which performs the signal processing for the packet according to the algorithm. After performing the signal processing, the packet is transferred to a node identified by a transferring address of the packet via the data transferring hardware DH. On the other hand, if the node K1 does not store the algorithm, the fixed unit F1 performs the requesting function mentioned above. That is, the fixed unit F1 sends a request signal to the management system M1 via the control line C1 in order to find another node having the algorithm necessary for processing the packet (S2) The management system M1 selects and decides the most suitable node (i.e. node K2) having the algorithm by searching the data file and then reports the information indicative of the suitable node to the fixed unit F1 of the node K1 via the control line C1. Here the most suitable node can be decided in consideration of its traffic congestion, distance from the node K1 and so on. The fixed unit F1 sends, to the suitable node (the node K2), the packet to be processed and the request information including information of node K1 (address of the node K1 etc.) via the transmission line T2. The node K2 performs signal processing for the transferred packet by performing the algorithm and sends back the processed packet to the node K1 via the transmission line T2. The node K1 receives the processed packet and transfers it to a node indicated by the transferring address of the packet.

According to the first embodiment of the invention, since the management system M1 collectively manages the protocol information indicative of algorithm possessed in each node, if the fist node does not have algorithm needed for processing a certain packet, the first node can transfer the packet to the second node having the algorithm by obtaining the protocol information of the network management unit M1. As a result, the increase in the traffic for transferring the algorithm itself can be avoided, and the requirement of real time processing for packets that require real time processing, such as voice signals can be satisfied.

B. Second Embodiment of the Invention

FIG. 6 shows a communications network system according to the second embodiment, which is comprised of programmable nodes K1-K3 and a management system M1. A difference between the first embodiment and the second embodiment is that the nodes K1-K3 are replaced to the programmable nodes K1-K3. Accordingly, the packet transferred on the communication network system includes a program, and the programmable nodes K1-K3 execute the program before transferring the packet. For example, the program commands to reproduce a received packet and to transfer them to a plurality of other programmable nodes respectively.

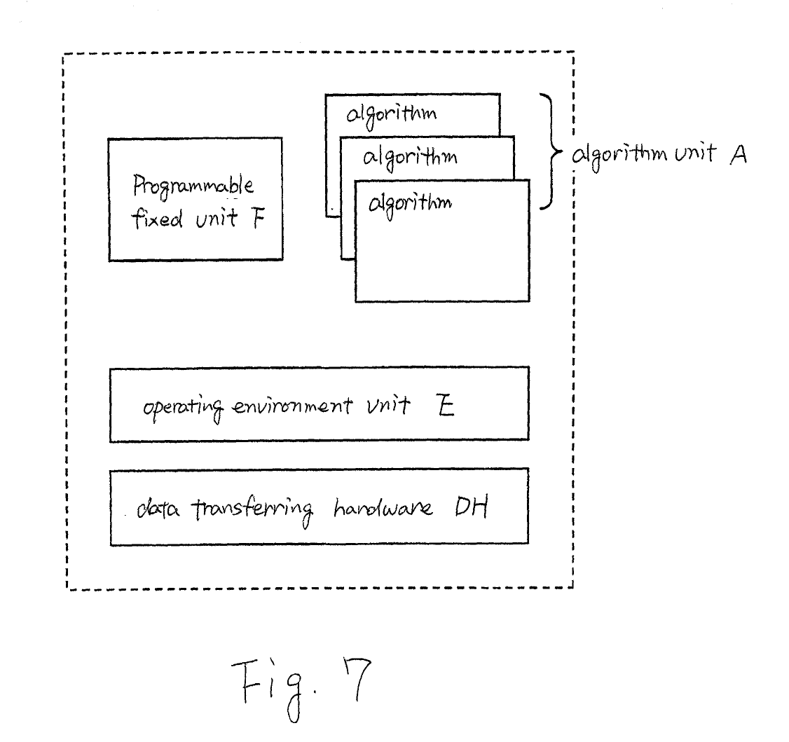

Next, the programmable nodes K1-K3 will be described with reference to the FIG. 7. Each of the programmable nodes K1-K3 comprises a programmable fixed unit F2, an algorithm unit A2, an operating unit E2 and data transferring hardware DH2. The programmable fixed unit F2, the algorithm unit A2, the operating unit E2 are generally realized by software, and the data transferring hardware DH2 comprises a central processing unit (CPU), a memory unit and an I/O interface.

The programmable fixed unit F2 has a function to maintain a state of packets in data transferring functions and the function is generally realized by application software. However, all or a part of the functions may be performed by an operating system instead of the application software. The programmable fixed unit F2 detects a program included in a packet and executes the detected program. If algorithm is needed to execute the program and the node does not have the algorithm, the programmable fixed unit F2 can transfer the packets to another node having the algorithm. This function of the programmable nodes of the second embodiment is different from the nodes of the first embodiment. The programmable fixed unit F2 is also provided with a detecting function for detecting the algorithm or the program, which are needed for transferring a received packet and an requesting function for requesting the management unit M2 to send protocol information indicative of a node possessing the algorithm necessary for transferring packets or for executing the program.

The algorithm units A2, the operating unit E2 and the data transferring hardware DH2 have the same function as the corresponding ones of the first embodiment. Consequently, their explanations are omitted here. Similarly, the management system M2 has the same function as that of the first embodiment shown in FIG. 3. As shown in FIG. 4, the management system M2 has a data file indicative of a relationship between the algorithm and the nodes.

The data transferring operation performed on the communication network system according to the second embodiment will be described below. As mentioned above, since the management system M2 collectively manages the protocol information that indicates algorithm possessed in each node, if the program included in the received packet requires algorithm, the first node can find the second node having the algorithm by requesting the network management unit M1 to send protocol information. In addition, if the received packet does not include a program, its data transferring operation is the same as that of the first embodiment.

Next, a registering operation will be described below. The management system M2 sends request packet signals to each of the nodes K1-K3 via the control lines C1-C3. In response to the reception of the request packet signals, each node informs the management system M2 of respective algorithm that is stored in each node as protocol information. The algorithm management unit P2 makes and stores the data file indicative of nodes and the corresponding algorithm as shown in FIG. 4. The request packet signals are sent to each node periodically, and then the data file is renewed in response to the reception of the protocol information replied by each node. Alternatively, each node can send the protocol information voluntarily and periodically regardless of receiving the request packet signals.

The data transferring operation will be described in detail with reference to FIG. 7. It is assumed that the programmable node K1 (shown in FIG. 6) receives a packet including a program. The packet is provided to the programmable fixed unit F2. The programmable fixed unit F2 executes the program and detects algorithm needed to execute the program or to transfer the packet. Further, the programmable fixed unit F2 examines whether or not the programmable node K1 stores the algorithm in the algorithm unit A2. If the programmable node K2 has the corresponding algorithm, the packet is supplied to the algorithm unit A2, and then the program is executed according to the algorithm. After executing the program, the packet is transferred to a node identified by a transferring address of the packet via the data transferring hardware DH2. On the other hand, if the node K1 does not have the corresponding algorithm, the programmable fixed unit F2 performs the requesting function. That is, the programmable fixed unit F2 sends the request signal to the management system M1 via the control line C1 in order to obtain the protocol information. The management system M1 selects and decides the most suitable node (i.e. node K2) having the algorithm by searching the data file and then notifies information of the node K2 to the fixed unit F2 of the programmable node K2 via the control line C1. Here, the most suitable node can be decided in consideration of its traffic congestion, its distance from the node K1 and so on. The programmable fixed unit F2 sends, to the node K2, the packet to be processed and the request information including information of node K1 (address of the node K1 etc.) via the transmission line T2. The node K2 performs signal processing for the received packet by using the algorithm and sends back the processed packet to the programmable node K2 via the transmission line T2. The programmable node K2 receives the processed packet and transfers it to a node indicating the transferring address of the packet.

According to the second embodiment of the invention, in addition to the effects of the first embodiment, further effects can be obtained. When a received packet includes a program that requires algorithm and a received node does not have the algorithm, the node easily finds another node having the algorithm. Thus, the programmable node can obtain the processed packet by transferring the packet to another node without transferring the algorithm itself. As a result, if the packet includes a program that requires algorithm, the increase in the traffic for transferring the algorithm itself can be avoided, and the requirement of real time processing for packets, such as voice signals, can be satisfied.

C. Other Embodiments

The communication network system according to the first embodiment has been composed of the first group of nodes K1-K3 each having a function for transferring packets. Furthermore, the communication network system according to the second embodiment has been composed of the second group of programmable nodes each having functions for transferring the packets and for executing a program included in the packet. However, the invention can be adapted to a hybrid communication network system comprising the first and second groups of nodes explained in the first and second embodiment of the invention.

In the first and second embodiments, each node requests the management system M1 to send protocol information regarding algorithm of the management system M1 or M2 after examining whether the algorithm is stored in an algorithm unit of each node. However, it can be possible to first request the management system M1 or M2 to send the algorithm information of after recognizing the necessary algorithm without examining whether the algorithm is stored in the algorithm unit.

The invention has been described in detail with respect to preferred embodiments, and it will now be apparent from the foregoing to those skilled in the art that changes and modifications may be made without departing from the invention in its broader aspects, and the invention, therefore, as defined in the appended claims is intended to cover all such changes and modifications as fall within the true spirit of the invention.

What is claimed is:

1. A data transferring method performed in a communication network comprising a management system and a plurality of nodes, the method comprising steps of;
storing protocol information in the management system, the protocol information indicating transferring functions operable by each of the plurality of the nodes,
receiving, at a first node, a packet having a destination address,
detecting, at the first node, a transferring function needed for transferring the packet,
requesting the management system to send the first node a second node information regarding a second node having the transferring function if the transferring function is not stored in the first node,
sending the second node information from the management system to the first node,
sending the packet from the first node to the second node to perform the transferring function for the packet, according to the second node information,
returning the packet from the second node to the first node, and
transferring the packet to the destination address.

2. A data transferring method according to claim 1, wherein the step of storing protocol information further comprises steps of;
sending, from the management system to each of the plurality of nodes, a request signal that request to register the transferring function stored in a node,
replying, from each node to the management system, a transferring function stored in a node in response to receipt of the request signal, and
storing the transferring function in the management system.

3. A data transferring method according to claim 1, the step of storing the algorithm information further comprises steps of;
periodically sending, from the each of the plurality of nodes to the management system, a transferring function stored in a node, and
storing the transferring function in the management system.

4. A data transferring method according to claim 1, wherein the protocol information is algorithm or a program needed for transferring the packet.

5. A data transferring method according to claim 1, wherein the step of requesting the management system to send the first node the second node information further comprises steps of;
examining whether the transferring function is stored in the first node, and
sending a request signal to the management system to obtain the second node information if the transferring function is not stored in the first node.

6. A data transferring method according to claim 1, wherein the packet includes a program and the step of detecting a transferring function is detecting the algorithm needed for transferring the packet or for executing the program.

7. A communication network system comprising a management system and a plurality of nodes, wherein the management system comprises;
an algorithm management unit for storing protocol information that indicates a transferring function possessed by each of the plurality of nodes, and
a network management unit for communicating with the plurality of nodes and for providing node information that indicates a node having a transferring function based on the protocol information, and
a first nodes comprises;
a detecting unit for detecting a required transferring function needed for transferring a received packet having a destination address,
a requesting unit for sending a request signal to the network management unit to obtain a second node information indicating a second node having the required transferring function when the first node is not provided with the required transferring function, and
a transferring unit for transmitting the received packet to the second node according the second node information to perform the required transferring function for the received packet and for transferring the received packet to the destination address after receiving the received packet from the second node.

8. A communication network system according to claim 7, wherein the transferring function indicates algorithm needed for transferring a packet.

9. A communication network system according to claim 7, wherein the transferring function indicates a program needed for transferring a packet.

10. A communication network system according to claim 7, wherein the algorithm management unit comprises;
means for sending, to each of the plurality of nodes, collecting order signals that request to register a transferring function stored in each node,
means for receiving, from each of the plurality of nodes, the transferring function in each of the plurality of nodes, and
means for renewing the transferring function.

11. A communication network system according to claim 10, wherein the first node further comprises means for replying, to the management system, transferring information stored in each node in response to the collecting order signal.

12. A communication network system according to claim 7, wherein each of the plurality of the nodes further comprises means for periodically registering, to the management system, the transferring function possessed by each of the plurality of nodes.

13. A communication network system according to claim 7, wherein the requesting unit comprises;
means for examining whether the required transferring function is stored in the first node,
means for requesting the management system to send the first node the second node information if the required transferring function is not stored in the first node, and
means for receiving the second node information.

14. A node in a communication network system, the node comprising;
a receiving means for receiving a packet,
an algorithm detecting means for detecting a required transferring function needed for transferring the packet,
an requesting means for requesting a management system, which stores protocol information indicating a transferring function possessed by each of the plurality of nodes, to send the node a second node information regarding a second node having the required transferring function if the required transferring function is not stored in the node;
an requesting means for requesting the management system to obtain the second node information, and
a transmitting means for transmitting the packet to the second node based on the second node information,
wherein the node receives, from the second node, a performed packet that the required transferring function is performed by the second node and transfers the performed packet to a destination address.

15. A node according to claim 14, wherein the packet includes a program, and the algorithm detecting means detects the algorithm needed for transferring the packet and for performing the program.
